(19) United States
(12) Patent Application Publication
(10) Pub. No.: US 2024/0298267 A1
(43) Pub. Date: Sep. 5, 2024

(54) LOAD THROTTLING FOR BATTERY OPERATED DEVICES

(71) Applicant: Rosemount Inc., Shakopee, MN (US)

(72) Inventors: Eric Russell Lovegren, Monticello, MN (US); Brian Lee Westfield, Victoria, MN (US)

(21) Appl. No.: 18/177,421

(22) Filed: Mar. 2, 2023

(51) Int. Cl. H04W 52/02

(52) U.S. Cl. CPC H04W 52/0274; H04W 52/0203

(57) ABSTRACT

A device includes a radio operating on a predetermined schedule, and a battery configured to supply power to the radio for radio operation. A radio controller is configured control to radio operation. A voltage indicating circuit is configured to monitor a voltage of the battery, and to provide an output signal indicative of a battery voltage sufficient to power radio operation. When the output signal is active, the radio controller allows operation of the radio on the predetermined schedule. When the output signal is inactive, the radio controller adjusts operation of the radio to maintain radio operation.

### BACKGROUND

A typical time synchronized radio has a defined schedule in which it should either transmit or receive data. This requires a certain amount of power which is highly dependent on the schedule. In a battery-operated device, there reaches a point at which the battery cannot deliver enough power to maintain the requested radio activity and the voltage level will drop. At this point, the device runs the risk of having the available voltage drop below a reset voltage for the radio, which can cause the radio to reset and not perform its task. Multiple resets, especially in a short period of time, can lead to a situation in which the radio may fail, and not recover from a reset situation, despite the battery still having sufficient power for further operation.

Radio load influences battery operation over temperature and time. In certain conditions, or with certain age of the battery, the available power may not be sufficient to perform a complete original predetermined schedule of operation of transmissions and receptions. Reduced battery power can lead to devices resetting and falling offline with little to no warning.

### SUMMARY

A device includes a radio operating on a predetermined schedule, and a battery configured to supply power to the radio for radio operation. A radio controller is configured control to radio operation. A voltage indicating circuit is configured to monitor a voltage of the battery, and to provide an output signal indicative of a battery voltage sufficient to power radio operation. When the output signal is active, the radio controller allows operation of the radio on the predetermined schedule. When the output signal is inactive, the radio controller adjusts operation of the radio to maintain radio operation.

A method of radio load throttling in a device includes monitoring available power from battery of the device, and controlling radio frequency (RF) activity of the radio based on available power from a battery of the device. Controlling RF activity includes operating the radio on a known transmitting and receiving schedule when the battery has sufficient power for scheduled RF activity, and adjusting the RF activity to maintain radio operation when the battery does not have sufficient power for scheduled RF activity.

### BRIEF DESCRIPTION OF THE DRAWINGS

FIG. 1 is a block diagram of a location awareness system on which embodiments of the present disclosure may be practiced;

FIG. 2 is a graph of radio operation in a system of the prior art;

FIG. 3 is a block diagram of a load throttling device according to an embodiment of the present disclosure;

FIG. 4 is circuit diagram of the load throttling device of FIG. 3; and

FIG. 5 is a graph of radio operation in a system employing embodiments of the present disclosure.

### DETAILED DESCRIPTION

The present disclosure provides embodiments of a method of load throttling a radio in a location awareness system. While such a system is described, it should be understood that radio throttling may be performed based on the methods of the various embodiments in different devices having radios that operate on a battery with limited amounts of power, such as but not limited to wireless field devices used in industrial process monitoring and controlling.

In a device containing a radio, the amount of power the radio consumes varies depending on the number of transmissions (TX) and receptions (RX) the radio performs. With a battery-operated device there is a limited amount of power that the device can supply. One such device is the Rosemount® WirelessHART location anchor which utilizes a time synchronized radio for communicating with location tags and has a battery for its power supply.

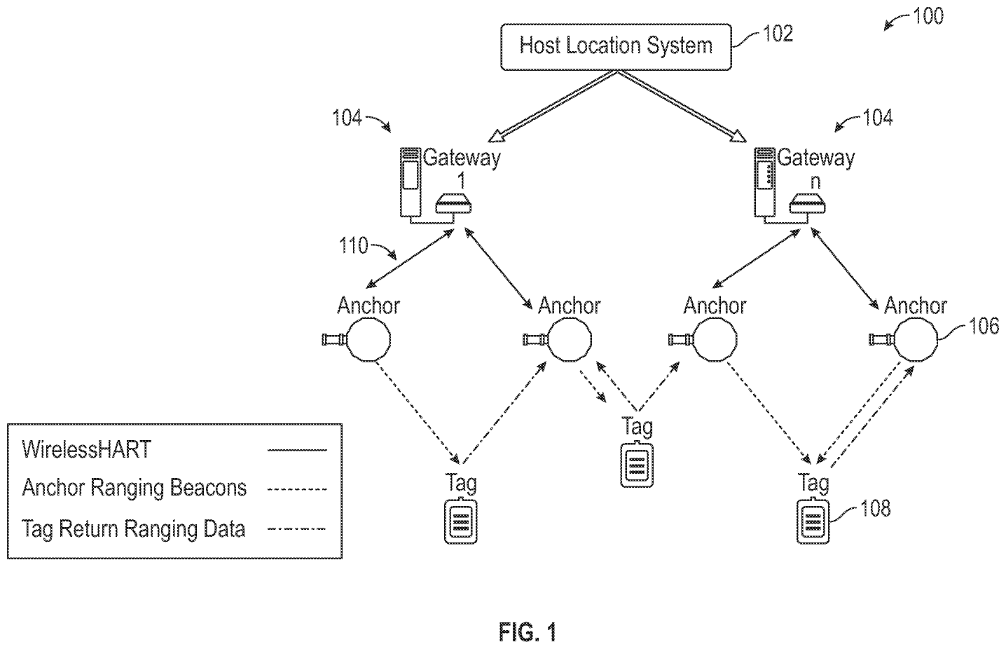

FIG. 1 is a block diagram of a location system 100 on which embodiments of the present disclosure may be practiced. Location awareness system 100 includes a host 102 connecting to a number of gateways 104. The gateways operate gateway networks 110 connecting to a plurality of anchors 106. The anchors 106 connect to the gateways 104 in one embodiment on a WirelessHART network 110 The anchors 106 each have a network to connect to tags 108 to do ranging for identification of the locations of the various tags. The system works on a synchronized time clock and uses a scheduled series of radio frequency (RF) communications powered by internal batteries within the tags and the anchors.

In this type of system, each anchor 106 is synchronized to the WirelessHART network 110 and each tag 108 is synchronized to the anchors 106. For a tag 108 to keep synchronized, the anchors 106 near the tag 108 periodically send a beacon message using their location radio. The tags 108 use the message to synchronize their clocks and extract location ranging information. That information is sent back to any anchor 106 that is listening and then forwarded onto the host system 102. For this type of system 100, keeping the anchors online and operational is important for keeping tags 108 connected to the location system 102.

With global time synchronization, each location anchor 106 runs a schedule for its radio in which it either transmits a beacon or receives tag 108 data. This schedule repeats itself at a frame interval (e.g., 16-20 seconds, although that frame interval may be different without departing from the scope of the disclosure) and the number of scheduled receives made during the frame is dependent on the number of tags 108 the anchor 106 is listening for. For this reason, the load on an anchor 106 may vary from device to device making it a challenge to design a power supply to handle all conditions.

Embodiments of the present disclosure are provided to ensure that the anchor radio consumption does not exceed what its battery can supply with a healthy battery. In this condition, the battery maintains its voltage and provides the power for the radio load. However, as a battery becomes depleted and/or the ambient temperature drops, these types of systems can run into issues. As the battery ages, the internal resistance will increase such that a large current draw will result in a drop in voltage at the battery. As the voltage drop increases, it reaches a point at which the system can no longer operate, and the device will reset. Without a significant change in its power consumption the device may never fully recover until the battery is replaced. For the anchor, the resetting of the device results in dropping off the WirelessHART network and a loss in connection to nearby tags.

Along with an aging battery, cold temperatures will cause a similar effect. In both cases, the resulting reset is not desired behavior and may occur well before the battery is totally depleted. Therefore, the realized life expectancy of the battery is lowered since there is remaining charge left in the battery yet it becomes unusable.

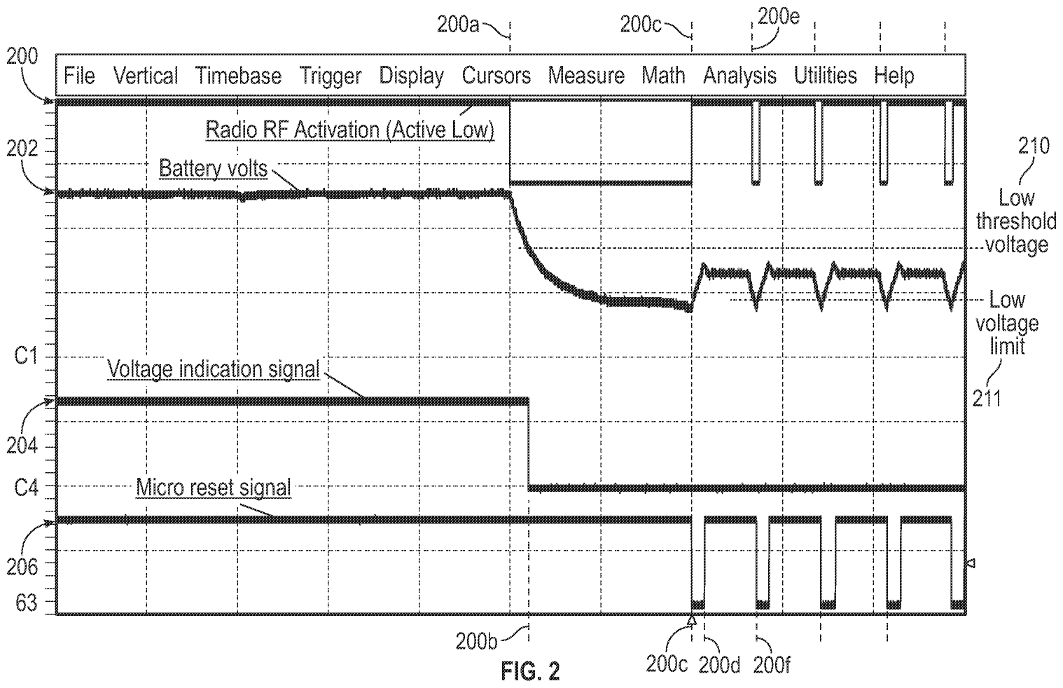

This situation is shown in the graph of FIG. 2. Radio RF activation is shown at line 200. Battery voltage is shown at line 202. A voltage indication signal is shown at line 204, and a micro reset signal for a device is shown at line 206. When radio RF activity starts at time 200a, battery voltage also begins to drop, eventually reaching and passing a low voltage threshold 210 at point 200b. At point 200b, as voltage continues to drop with RF activity of the radio, a voltage indication signal moves from active to inactive, indicating that battery voltage is dropping below the low voltage threshold 210. High load current, such as location radio RF receiver activity, cause the drop in voltage. At time 200c, battery voltage drops to a low voltage limit 211. At this point, the battery does not have sufficient voltage to power the device, which resets. This drops the device off the network, and RF activity stops. As voltage recovers, the device recovers from reset at time 200d and rejoins the network. RF activity starts again at time 200e, but voltage has only recovered somewhat and quickly drops to the low voltage limit 211 again, and at time 200f, the device resets again. This process may repeat itself a number of times as long as the device can rejoin the network successfully. This leads to unreliable and bad performance of the device, even if sufficient battery power is still present. If the device is to recover, it usually recovers due to changes in ambient condition allowing increased battery output. However, too many resets, and the device may permanently drop off the network and be unable to rejoin. In such a situation, there is still usable battery left, but due to high radio activity or load, remaining battery becomes unusable.

The radio load throttling embodiments of the present disclosure are used to increase battery life and reduce the chance of device resets. In lieu of running a fixed transmit and receive schedule the anchor controls radio RF activity based on the available power to the device. When the device has a good power source, the radio adheres to its full schedule. However, as the power to the device is reduced, the device will sense this drop in power and automatically adjust its scheduled RF activity to compensate.

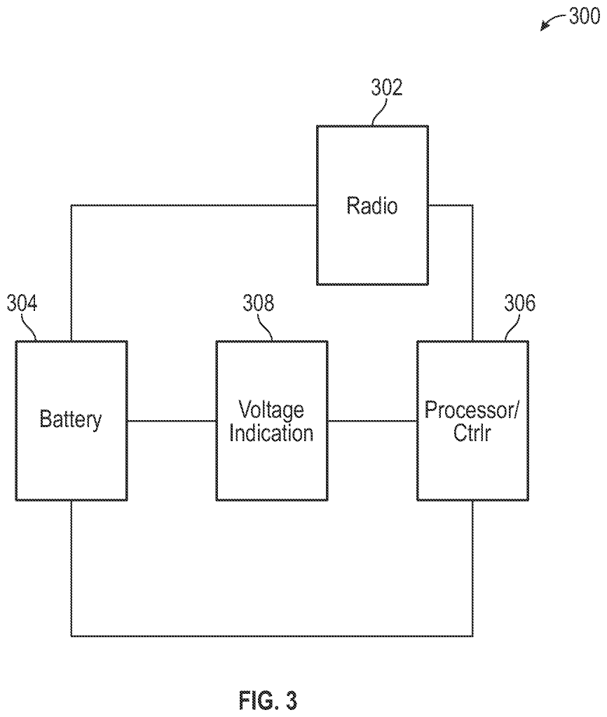

The location system, especially the tags and anchors, which are remotely located and may be powered by an internal battery, are subject to battery degradation and power loss due to age, ambient conditions, and the like. A radio throttling device such as an anchor 106 or tag 108 is shown in block diagram in FIG. 3. Device 300 comprises, in one embodiment, a radio 302 operating on a predetermined schedule, and a battery 304 configured to supply power to the radio for radio operation. A radio controller 306 is coupled to the radio 302 to control radio operation. A voltage indicating circuit 308 is coupled to the battery and to the radio controller, and serves to monitor a voltage of the battery, and to provide an output signal to the radio controller. The output signal is indicative of a battery voltage sufficient to power radio operation.

When battery power is sufficient, an output signal from the voltage indication circuit 308 is active, and the radio controller 306 allows operation of the radio 302 on the predetermined schedule. When battery power drops below a threshold, and is insufficient for full schedule RF operation, the output signal is inactive. In this situation, the radio controller 306 adjusts operation of the radio 302 to maintain a supplied voltage over a reset voltage for the radio 302. Adjusting operation in one embodiment entails disabling radio operation when the output signal is inactive, to prevent a radio reset as discussed above. When the radio is disabled, it does not drop off the network and have to rejoin. In another embodiment, when the output signal is inactive, the radio controller adjusts operation of the radio by changing the schedule to a lower frequency of radio operation. When the output signal is inactive, in one embodiment, the radio controller is configured to provide a low voltage alert when the output signal is inactive.

As long as the battery is supplying sufficient voltage for normal operation, the radio controller is configured to follow the predetermined schedule with a voltage check of the battery prior to every transmission or reception in the predetermined schedule, and to load throttle when the output signal is inactive. A check of battery voltage is performed at the beginning of every scheduled RF activity. Still further, once an RF activity is started, monitoring continues in one embodiment. If the battery voltage drops below the threshold level of safe operation of the radio without a reset event occurring, RF activity is throttled when the threshold voltage is reached and the output signal becomes inactive.

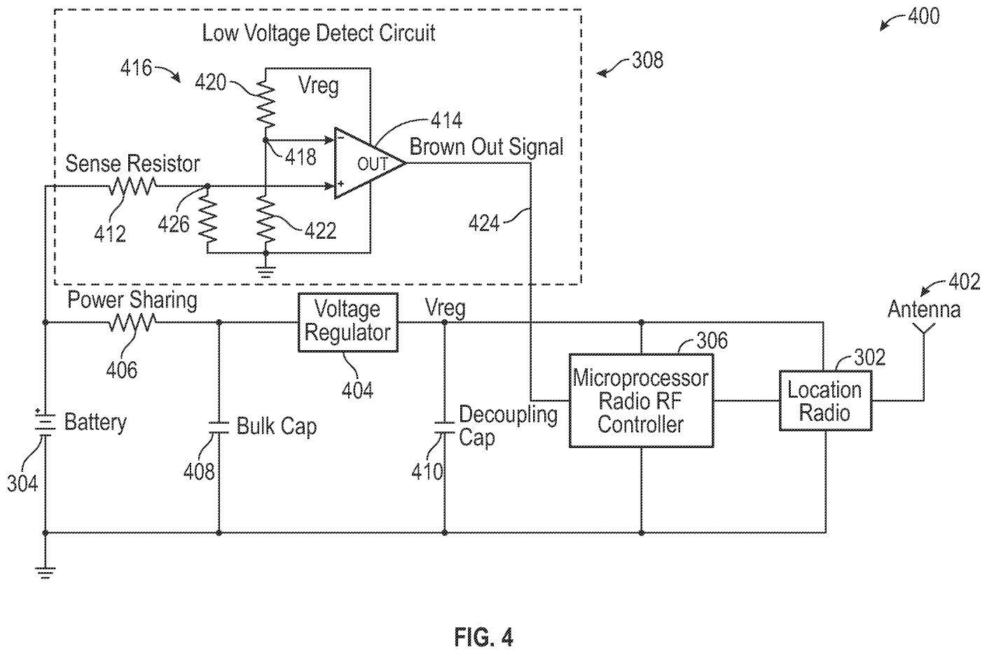

Referring now to FIG. 4, a more detailed view of a circuit 400 according to the embodiment of FIG. 3 is shown in circuit diagram form. Circuit 400 comprises radio 302 having antenna 402, battery 304, radio controller 306, and voltage indicating circuit 308. Additional components include a voltage regulator 404, power sharing resistor 406, bulk power storage component 408, and decoupling capacitor 410.

Voltage indicating circuit 308 comprises a sense resistor 412 coupled between the positive battery terminal and the non-inverting input of a comparator 414, such as an operational amplifier connected as a positive voltage comparator or the like, as an input voltage to the comparator 414 as identified at node 426. A voltage divider 416 providing a reference voltage, in this embodiment the voltage threshold, is coupled at its reference node 418 at the middle of the voltage divider 416 (e.g., the voltage threshold as described above) to the inverting input of comparator 414. When the battery voltage at node 426 is greater than the reference voltage at node 418, the output signal 424 is active (e.g., high). When the battery voltage at node 426 drops below the voltage at node 418, the output signal is inactive.

The threshold voltage at node 418 is determined by a portion of the voltage Vreg, the voltage output by voltage regulator 404, which is supplied to one end of the voltage divider 416, with the other end of the voltage divider 416 at ground. Therefore, the voltage supplied at the middle of the voltage divider, at node 418, is determined as a percentage of the voltage Vreg, with the value of resistors 420 and 422 chosen to make the voltage at node 418 the voltage threshold above at or above which the output signal 424 from amplifier 414 is active. When the voltage at the positive terminal, that is, the battery voltage, drops below the voltage at node 418, amplifier output signal 424 goes inactive. The inactive signal at 424 triggers the radio controller 306 to throttle RF activity.

It should be understood that other low voltage detection circuits may be used without departing from the scope of the disclosure.

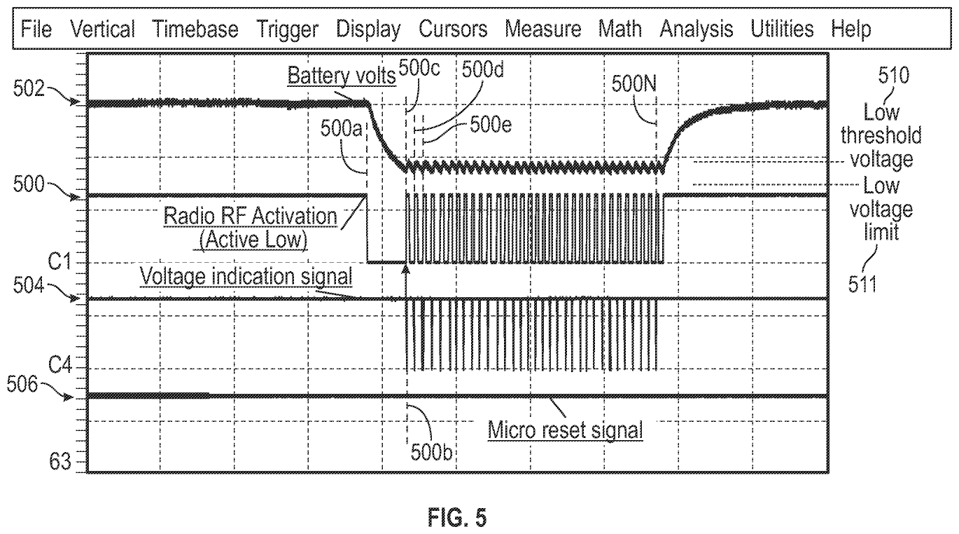

Operation of the embodiments of the present disclosure is shown in graph form in FIG. 5. Radio RF activation is shown at line 500. Battery voltage is shown at line 502. A voltage indication signal is shown at line 504, and a micro reset signal for a device is shown at line 506. When radio RF activity starts at time 500a, battery voltage also begins to drop. Voltage indication signal 504, which is determined by a voltage indication circuit such as circuit 308, is indicative of monitoring of the voltage. When the voltage drops to a low voltage threshold 510 of safe operation, at voltage level Vt, the voltage indication circuit deactivates the voltage indication signal 504 at time 500b. This signal indicates to the radio controller to throttle RF activity, as shown at time 500c. The voltage indication circuit 308 monitors battery voltage and when it senses a low voltage (e.g., a drop to the low voltage threshold 510), the voltage indication signal drops and the radio controller disables the radio until sufficient power is available to operate the radio without resetting the radio. The voltage indication circuit 308 checks the power on every RF activation, as indicated at times 500d, 500e . . . 500N. At each initiation of RF activity, if the voltage is sufficient, RF activity commences. If voltage is not sufficient, RF activity is throttled, If during operation, battery voltage drops to the low threshold 510. RF activity is throttled. At no point in time do the embodiments of the present disclosure allow the battery voltage to drop below the low threshold voltage 510 without throttling the RF activity. This keeps the device radio above a low voltage limit, or reset voltage, 511 that would cause the device to reset and potentially drop off the network. In this way, the embodiments of the present disclosure use a lower voltage capacity battery more fully.

In another addition to the embodiments of the present disclosure, a bulk storage component (e.g., a bulk capacitance) may be added to assist through situations when the radio activity is higher. This reduces the duty cycling giving full capability even with a lower battery voltage. This is accomplished in one embodiment by adding enough capacitance (e.g., bulk storage component 408) so that an initial current draw for the radio load will be completely or mostly supplied by the bulk storage component 408. This allows for some number of scheduled radio tasks to be performed without duty cycling even if the battery is weak. The bulk storage component is charged during idle RF time by the battery. Once there is more activity than the stored capacitance can supply, the battery supplies additional current needed and radio load throttling engages as discussed above. The use of the bulk capacitance can extract power from the battery even at lower capacity since the bulk capacitance is charged during idle RF activity. While there is some cost to the battery to charge the bulk capacitance, such a bulk capacitance can increase usable battery life.

Bulk storage component 408 and its use are discussed further below. In order to smooth out spikes in power consumption that may lead to a drop in battery voltage sufficient to trigger the output signal to drop, bulk storage component 408 is used in one embodiment. Bulk storage component 408 comprises a bulk capacitor or bulk capacitor bank in one embodiment. Bulk storage component 408 is coupled across the terminals of battery 304, with a power sharing resistor 406 used to smooth operation thereof. Bulk storage component 408 charges when RF activity is at idle. When RF activity is to be undertaken, initial power for the RF activity is provided by the charged bulk storage component.

Specifically, in this embodiment, battery load is kept as low and static as possible. High load currents especially during radio transmissions reduce the usable life of a battery. This can become problematic as the battery ages, and its equivalent series resistance (ESR) increases. To reduce peak loads on the battery, the power sharing resistor 406 and bulk storage component 408 are used ahead of voltage regulator 404. The power sharing resistor 406 serves two purposes. It softens current used to recharge the bulk storage component 408 during idle RF time periods, and it allows the bulk storage component 408 to carry most of the peak current used during RF transmissions. The voltage indication circuit 308 monitors the voltage on the battery 304 via the sense resistor 412 and comparator 414 to determine if the battery is capable of supporting RF activity. If the battery voltage begins to dip, then the radio controller receives the inactive output signal 424 and throttles RF activity to prevent the battery voltage from collapsing. During throttled time periods a user is alerted with an alarm provided in one embodiment via a wireless interface.

The radio may run, in various configurations, in more than one mode of operation. Two such modes are 1) single message transmissions/receives and 2) timed continuous receive mode which usually lasts for some number of seconds. Mode 1) is a scheduled listen where the radio is active only when a receive is scheduled. Mode 2) is an open listen mode in which the receiver is enabled waiting for a message to arrive. An open listen may last for minutes, but is typically within a rough scheduled period, often on the order of 16 seconds or less. Transmissions are all either scheduled, or are typically very short in duration. Continuous transmission is not allowed under Federal Communication Commission (FCC) guidelines.

Mode 1) is typically used when all devices in a system are time synchronized together. In this configuration, the devices run off a timed schedule that repeats every frame time (e.g., 16 seconds). Their radios are only turned on to transmit or receive a single message when scheduled to do so. This results in a typical radio on time of 4-8 milliseconds (ms) per message. In this configuration, a battery voltage check is performed only prior to the transmit or receive operation. There may be hundreds of transmissions/receives in fairly rapid succession over the time frame, with a radio off time in between a transmission/receive of on the order of 20 ms. Prior to each transmission/receive, the battery voltage is checked. If the battery voltage exceeds the threshold voltage, the operation proceeds. If not, then load throttling is initiated.

Load throttling may take several different forms without departing from the scope of the disclosure. For example, the schedule of transmissions/receives may be slowed down, such as in transmission/receive on a lower frequency or the like. In one embodiment, all radio RF operation is halted until the battery voltage is sufficient to support operations (e.g., the battery voltage is above the voltage threshold).

In mode 2), in which the receiver is turned on for a longer period (e.g., for 10 seconds or so) a single voltage check at the beginning of the period may not be sufficient given the current load the radio will consume during extended operation. In this situation, while the radio is actively receiving, voltage checks are in one embodiment made continuously during the period the radio is on. If, during that period, the battery voltage drops to the threshold voltage, voltage throttling such as shutting down the shut down the radio until the power recovers may be performed.

In one embodiment, when the output signal drops, a warning is triggered by the radio controller. A status warning flag is set in one embodiment to indicate that RF throttling has been engaged. Status flags are sent to a host system periodically using WirelessHART's Additional Status command 48. The host system can monitor flags to determine when the battery should be replaced.

With radio load throttling according to embodiments of the disclosure, a power limited device can adjust its power consumption to match the power that is available. This keeps the device functional for a much longer time by extending the overall battery life. By reducing the radio load, the device is prevented from resetting, which allows for an uninterrupted connection to the WirelessHART network, and allows for advance warning to the user to replace the battery. During this time, the device maintains connection to the location system, reducing the impact to surrounding tags/devices.

Embodiments of the present disclosure have been presented that provide a radio load throttling apparatus and method that dynamically adjust power consumption of the radio to match the power that is available from the device battery. The embodiments help maintain the battery voltage to prevent the device from resetting. This in turn extends the overall battery life, and improves forewarning to a user that their device life may be bearing its end.

The result of the embodiments of the present disclosure is a device that performs as many radio transmissions or receptions as it can based on the amount of power it has. As the battery becomes weaker due to age or temperature effects, it is slower to respond to the radio's current demand. When this happens, the radio activity will be reduced to lower its average current load and prevent a system reset.

The embodiments of the present disclosure provide some advantages over existing systems, which include by way of example and not limitation, reducing the average radio current; preventing a device from resetting as the battery becomes weak; extending the runtime/battery life of the device; increasing the chances of reporting vital battery status to the user; and giving the user more time to schedule battery replacement, which reduces the anchor downtime. This also reduces the location ranging error for nearby tags that is created when an anchor drops offline.

What is claimed is:

1. A device, comprising:
a radio operating on a predetermined schedule;
a battery configured to supply power to the radio for radio operation;
a radio controller configured to control radio operation; and
a voltage indicating circuit configured to monitor a voltage of the battery, and to provide an output signal indicative of a battery voltage sufficient to power radio operation;
wherein when the output signal is active, the radio controller allows operation of the radio on the predetermined schedule; and
wherein when the output signal is inactive, the radio controller adjusts operation of the radio to maintain radio operation.

2. The device of claim 1, wherein maintaining operation of the radio comprises maintaining a supply voltage greater than a reset voltage for the radio.

3. The device of claim 1, wherein the radio controller adjusts operation of the radio by disabling the radio when the output signal is inactive.

4. The device of claim 1, wherein the radio controller adjusts operation of the radio by changing the schedule to a lower frequency of radio operation when the output signal is inactive.

5. The device of claim 1, wherein the radio controller is configured to provide a low voltage alert when the output signal is inactive.

6. The device of claim 1, wherein the radio controller is configured to follow the predetermined schedule with a voltage check of the battery prior to every transmission or reception in the predetermined schedule, and to load throttle when the output signal is inactive.

7. The device of claim 1, wherein the radio controller is further configured to monitor the output signal during active transmissions and receptions of the radio, and to throttle transmissions and receptions when the output signal switches to inactive.

8. The device of claim 1, and further comprising a bulk storage component coupled between the battery and the radio controller and configured to supply power for transmissions and receptions prior to using power from the battery.

9. The device of claim 8, wherein the bulk storage component is charged using power from the battery when the radio is idle.

10. The device of claim 8, wherein the bulk storage component comprises a bulk storage capacitor charged by the battery, and wherein when a transmission or reception according to the predetermined schedule is to be made, power for the radio is provided by enabling the bulk storage capacitor for powering the transmission or reception.

11. The device of claim 10, wherein the bulk storage component further comprises a power sharing resistor coupled between the battery and the bulk storage capacitor.

12. The device of claim 1, wherein the voltage indicating circuit comprises:
a comparator having an inverting input and a non-inverting input, and an output;
a sense resistor coupled between a positive terminal of the battery and the non-inverting input of the comparator; and
a voltage divider providing a reference voltage coupled to the inverting input of the comparator, the comparator configured to output an active signal when the battery voltage exceeds the reference voltage, and to output an inactive output signal when the battery voltage drops below the reference voltage.

13. A method of radio load throttling in a device, comprising:
monitoring available power from battery of the device; and
controlling radio frequency (RF) activity of the radio based on available power from a battery of the device;
wherein controlling RF activity comprises:
when the battery has sufficient power for scheduled RF activity, operating the radio on a known transmitting and receiving schedule; and
when the battery does not have sufficient power for scheduled RF activity, adjusting the RF activity to maintain radio operation.

14. The method of claim 13, wherein controlling RF activity to maintain radio operation comprises protecting the radio against radio reset.

15. The method of claim 13, wherein monitoring available power comprises:
sensing a battery voltage with a voltage indicating circuit;
comparing the sensed battery voltage against a low voltage threshold;
providing an output signal that is active when the battery has sufficient power and that is inactive when the battery does not have sufficient power.

16. The method of claim 15, wherein controlling RF activity of the radio is performed by a radio controller, the radio controller receiving the output signal and adjusting operation of the radio by disabling the radio when the output signal is inactive.

17. The method of claim 15, wherein controlling RF activity of the radio is performed by changing the schedule to a lower frequency of radio operation when the output signal is inactive.

18. The method of claim 15, and further comprising sensing the battery voltage check of the battery prior to every transmission or reception in the predetermined schedule, and load throttling when the output signal is inactive.

19. The method of claim 15, and further comprising monitoring the output signal during active transmissions and receptions of the radio, and throttling transmissions and receptions when the output signal switches to inactive.

20. The method of claim 13, and further comprising charging a bulk storage component configured to supply power for transmissions and receptions during idle periods of RF activity.
